(19) United States
(12) Patent Application Publication
(10) Pub. No.: US 2024/0118875 A1
(43) Pub. Date: Apr. 11, 2024

(54) DEPLOYING OPTIMIZATION PROFILES FOR COMPILING COMPUTER PROGRAMS IN DATA CENTERS

(71) Applicant: Google LLC, Mountain View, CA (US)

(72) Inventors: Yu Wang, San Jose, CA (US); Dehao Chen, Fremont, CA (US); Phitchaya Mangpo Phothilimthana, Mountain View, CA (US)

(21) Appl. No.: 18/482,738

(22) Filed: Oct. 6, 2023

Related U.S. Application Data
(60) Provisional application No. 63/414,335, filed on Oct. 7, 2022.

(51) Int. Cl. G06F 8/41

(52) U.S. Cl. CPC G06F 8/41

(57) ABSTRACT

Methods, systems, and apparatus, including computer programs encoded on computer storage media, for feedback-directed optimization. One of the methods includes maintaining a data store comprising a plurality of optimization profiles that are used by a compiler to compile respective computer programs. The computer programs can be invoked by a set of executing workloads. Operations are repeatedly performed that include, for each optimization profile in at least a subset of the optimization profiles: determining or predicting whether the optimization profile is a valid optimization profile for a current software version of the compiler, and in response to determining or predicting that the optimization profile is not a valid optimization profile for the current software version of the compiler, removing the optimization profile from the data store.

### CROSS-REFERENCE TO RELATED APPLICATIONS

This application claims the benefit of U.S. Provisional Application Ser. No. 63/414,335, filed Oct. 7, 2022, the entire contents of which are incorporated by reference herein.

### BACKGROUND

This specification relates to compilation caches that store compilation outputs previously generated by a compiler in response to processing a computer program.

### SUMMARY

This specification describes systems, methods, devices, and techniques for generating and maintaining compiler optimization profiles that can be used by a compiler to improve the efficiency with which it compiles one or more computer programs. The use of an optimization profile can improve the efficiency of a compilation process over a compilation process that does not use an optimization profile (e.g., relative to use of a default, non-optimized compiler profile). The disclosed techniques can be implemented as computer programs on one or more computers in one or more locations.

In some implementations, a system is configured to determine, from a set of computer programs that are executed by a fleet of workloads, a subset of computer programs that are invoked most often or for the greatest duration by the workloads relative to other computer programs in the set. The system can then determine to generate optimization profiles for the computer programs in the determined subset, in order to improve the efficiency of the system by the greatest degree.

The system can further perform auditing on the optimization profiles after the generation of the optimization profiles, to ensure that the optimization profiles are still valid given the current software version of the compiler and/or to ensure that the optimization profiles still provide improved performance of the compilation relative to the default profiles.

The subject matter described in this specification can be implemented in particular embodiments so as to realize one or more of the following advantages.

Using techniques described in this specification, a system can generate and use optimization profiles for compiling a computer program without affecting existing workloads that use the computer program and that are already being executed on a user's behalf. Because the generation of the optimization profiles can be performed in the background while a workload is executing, the optimization profile can be rolled out without interrupting the workload, such that the next time that the workload invokes the computer program the compiler can determine to use the optimization profile to compile the computer program, e.g., instead of a default profile.

Furthermore, because the compiler obtains the optimization profile that has been pre-generated, the use of the optimization profile for compiling the program adds minimal or zero additional time and computational overhead to the compilation process. The optimization profile can explicitly define one or more settings or parameters for the compiler, such that the compiler can be directly configured from the optimization profile by compiling a program in accordance with the settings or parameters defined in the optimization profile (e.g., rather than requiring the compiler itself to derive settings from data contained in the optimization profile).

Using techniques described in this specification, a system can add a new optimization profile to a set of optimization profiles using a submission of a change list that identifies all changes to a repository of code shared by at least some workloads in the fleet of workloads. Thus, if an error occurs, the system can revert to a previous version of the repository identified by a previous change list, including reverting to the set of optimization profiles of the previous version. Furthermore, the performance of a particular compilation can be exactly reproduced by reverting to a previous version as identified by a previous change list.

The techniques disclosed herein can be particularly useful for accelerated linear algebra (XLA) compilers or other compilers that perform compilation of computer programs representing a machine-learning model (e.g., a computational graph for a neural network) or a portion of a machine-learning model (e.g., a subgraph corresponding to a subset of nodes in a neural network).

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system.

FIG. 2 is a flow diagram of an example process for generating new optimization profiles.

FIG. 3 is a flow diagram of an example process for determining whether existing optimization profiles are valid.

Like reference numbers and designations in the various drawings indicate like elements.

### DETAILED DESCRIPTION

This specification describes systems, methods, devices, and related techniques for generating and maintaining optimization profiled for compiling computer programs.

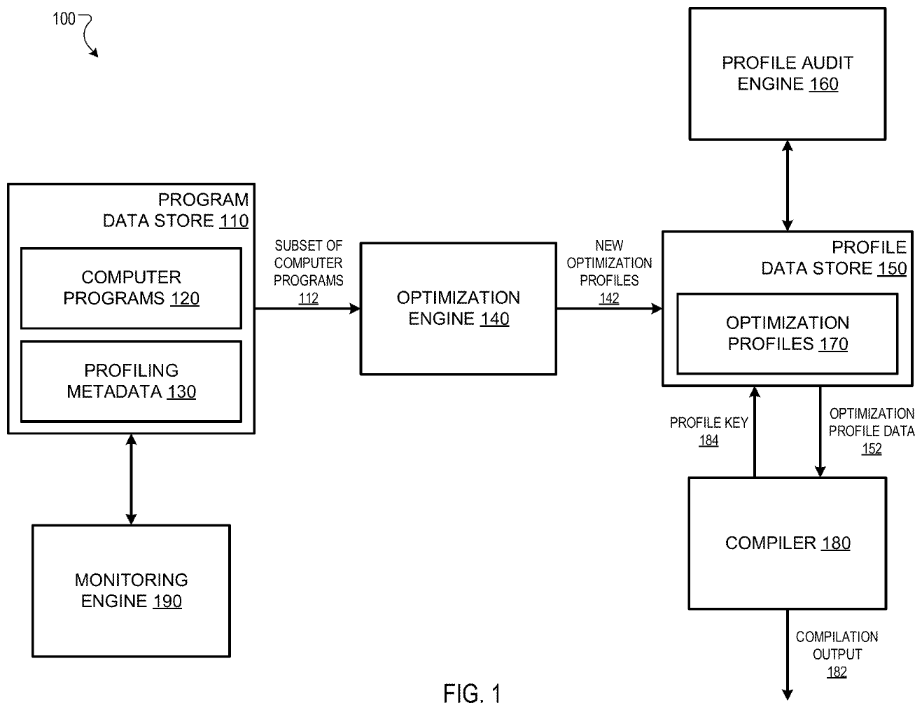

FIG. 1 is a diagram of an example compilation system 100. The system 100 is an example of a system implemented as computer programs on one or more computers in one or more locations, in which the systems, components, and techniques described below can be implemented.

The compilation system 100 is configured to generate, for each computer program 120 in a set of one or more computer programs, a respective compilation output 182 for the computer program 120, e.g., a compiled version of the computer program 120. The compilation system 100 can then provide the compilation output 182 to a system that executes the computer program 120, e.g., to perform a task defined by the computer program 120.

The external system can be any appropriate system configured to execute the computer program 120 using the compilation output 182, e.g., a central processing unit (CPU), an accelerator such as a graphics processing unit (GPU) or tensor processing unit (TPU), or a system having multiple such processing units or accelerators and optionally additional components such a memory and I/O interfaces.

In this specification, a computer program can be represented using data in any appropriate form. For example, a computer program can include computer code written in any appropriate programming language, e.g., a human-interpretable programming language such as Python, Java, C++, and so on. A computer program can be processed by a compiler (e.g., the compiler 180 described below) to generate a compilation output that represents the computer program in a different programming language, e.g., an assembly language or machine code that is not human-interpretable. The compilation output can then be processed by a computer system to execute the computer program.

In other words, in this specification, compilation is a process that translates a computer program from a source programming language to a target programming language, and a compilation output is the product of the compilation that represents the computer program in the target language.

In some implementations, the external system is configured to repeatedly obtain a compilation output 182 for a particular computer program 120 from the compilation system 100 and process the obtained compilation output 182 to execute the particular computer program 120. That is, at each of multiple execution cycles of the compilation system 100 and/or execution cycles of the external system (also called “iterations”, “execution stages,” or simply “stages” of the compilation system 100 and/or the external system), a compilation output 182 can be provided from the compiler system 100 to the external system. The compilation output 182 can be provided according to a push or pull model, e.g., with or without a request from the external system to the compilation system 100. In some implementations, the compilation system 100 generates a compilation output 182 for a particular computer program 120 at each execution stage.

In some implementations, the compilation system 100 is configured to perform “just-in-time” compilation, where the compilation system 100 generates the compilation output 182 during execution of the computer program 120, rather than before the execution of the computer program 120. For example, each of the multiple execution stages of the compilation system 100 can correspond to a respective invocation of the computer program 120 by the external system (e.g., during the execution of the computer program or a collection of multiple computer programs), where the external system sends a request to the compilation system 100 to provide a compilation output 182 for the computer program 120 at the time of the invocation, by the external system, of the computer program 120.

For one or more of the computer programs 120 in the set of computer programs, the computer program 120 can include one or more constituent parts, i.e., “modules” of the computer program 120. In some implementations, the computer program 120 is itself a module of a larger computer program that includes multiple modules. That is, the larger computer program can include multiple different computer programs, where the computer program 120 can be compiled by the compilation system 100 independently of the other modules of the larger computer program. For example, the execution of the computer program 120 can depend on one or more other computer programs that are modules of the larger computer program. In some other implementations, the computer program 120 can be executed in isolation, i.e., independently of any other computer programs.

Each computer program 120 in the set of computer programs can be any appropriate computer program that performs any appropriate task.

In some implementations, at least one computer program 120 defines the operations of a trained machine learning model, e.g., a neural network. Generally, the trained machine learning model can define operations including processing a model input to generate a model output representing a prediction about the model input. For example, the computer program 120 can define a graph (e.g., a TensorFlow graph) that defines the operations of passing activation tensors between respective neurons and neural network layers of the neural network.

In some other implementations, the computer program 120 defines only a portion of a trained machine learning model. For example, the computer program 120 can define a subgraph (also called a “cluster”) of a computational graph defining a trained neural network (i.e., a strict subset of the nodes of the computational graph, e.g., a TensorFlow graph), e.g., a single node, a single neural network layer, or a set of fused operations of the neural network. As another example, the computational graph can include operations that are not supported by the compiler 180 (e.g., which are not supported by an XLA compiler), and thus the computer program 120 can include only the operations of the machine learning model that are supported by the compiler 180.

A machine learning model entirely or partially defined by a computer program 120 can be configured to perform any appropriate machine learning task.

For example, the machine learning task may be a speech recognition task, where the machine learning model is configured to process a representation of an audio waveform to generate an output that characterizes a sequence of phonemes, characters, or words corresponding to the audio waveform.

As another example, the machine learning task may be a video analysis task, where the machine learning model is configured to process a sequence of video frames to generate an output that characterizes the video frames, e.g., by characterizing whether the video frames depict a person performing a particular action.

As another example, the machine learning task may be a natural language processing task, where the machine learning model is configured to process a portion of text to generate an output that characterizes the portion of text, e.g., by characterizing a translation of the portion of text into a different natural language.

As another example, the machine learning task may be an image processing task, where the machine learning model is configured to process an input that includes an image to generate a corresponding output, e.g., a classification output, a regression output, or a combination thereof. The machine learning model can be configured to process images of any appropriate type, e.g., RGB images, LIDAR images (e.g., point clouds), and so on.

As another example, at least one of the computer programs 120 is a training program adapted to train one or more machine-learning models (e.g., neural networks). Here, a task performed by the computer program 120 would be to train or facilitate training of a machine-learning model.

The compilation system 100 includes a program data store 110, an optimization engine 140, a profile data store 150, a profile audit engine 160, a compiler 180, and a monitoring engine 190.

The program data store 110 is configured to maintain data representing each computer program in the set of computer programs 120. The program data store 110, for example, can include memory storing intermediate representations of the computer program 120s such as HLOs that have been generated during the compilation process. The program data store 110 can additionally or alternatively store the original code of the computer programs 120. In some implementations, the program data store 110 can further maintain, for at least some and up to all of the computer programs in the set of computer programs 120, respective profiling metadata 130 that indicates whether (and/or to what extent) the computer program 120 is being or is to be compiled using an optimization profile 170 generated by the optimization engine 140 (as opposed, e.g., to a default profile). The profiling metadata 130 is described in additional detail below.

The profile data store 150 is configured to maintain a set of one or more different optimization profiles 170 by which the compiler 180 can compile respective computer programs 120 in the set of computer programs. In this specification, an optimization profile generally refers to data that indicates one or more configurable settings to be used by a compiler (e.g., the compiler 180) for compiling a computer program. That is, each optimization profile 170 stored by the profile data store 150 defines a particular configuration for the compiler that corresponds to the indicated settings. The optimization profile 170 can be predicted or otherwise constructed to cause the compiler to generate a compilation output for one or more respective computer programs 120 in an optimized manner. The optimization profile 170 can be constructed to optimize one or more criteria related to the performance of a compiled computer program, e.g., the execution efficiency of the compiled computer program and/or the accuracy of the compiled computer program. In this specification, the term “optimal” or “optimized” encompasses configurations that maximize or otherwise improve the favorability of one or more criteria relative to other identified configurations, but does not necessarily imply that the optimization profile will always cause a compiler to generate a compilation output that achieves an absolute or theoretically maximized outcome.

In some implementations, the profile data store 150 associates each optimization profile 170 with a profile key. For example, the optimization profiles 170 in the profile data store 150 can be indexed by profile key values. Each profile key can correspond to one or more respective computer programs 120 from the set of computer programs. That is, the profile data store 150 associates each profile key corresponding to a subset of the set of computer programs 120 with a respective optimization profile 170 by which the computer programs 120 in the subset for that profile key are to be compiled. In some implementations, the profile data store 150 maintains a first set of data that links or otherwise associates each profile key with a corresponding subset of computer programs 120 to which the key applies, and further maintains a second set of data that links or otherwise associates each profile key with a respective optimization profile 170 that should be used to compile the subset of computer programs 120 for that key.

Some or all of the optimization profiles 170 can have been generated by the optimization engine 140, as described in more detail below.

In some implementations, one or more of the optimization profiles 170 stored by the profile data store 150 have been generated (e.g., by the optimization engine 140) at least partially using feedback-directed optimization (also called profile-guided optimization). In general, feedback-directed optimization is a process that first involves compiling a computer program using a first optimization profile (or using no optimization profile at all, e.g., using default or randomized values for all parameters of the optimization) to generate a first compilation output. The first compilation output is then executed, and an optimization system monitors execution of the first compilation output to obtain performance characteristics (such as branch misses, cache misses, instruction misses, and so on) of the first compilation output. The optimization system then uses the performance characteristics to generate a new (second) optimization profile that is predicted to improve the performance of the execution of the compilation output for the computer program. That is, the second optimization profile, if used to re-compile the computer program to generate a second compilation output, is predicted to cause the performance of the second compilation output to be superior in one or more measures relative to the performance of the first compilation output, e.g., in terms of computational efficiency. In certain examples, the present techniques provide an improved feedback-directed optimization process for machine-learning workloads in which updates are made to one or more of: tile sizes, flags that identify whether/how to fuse operations (e.g., whether to fuse input/output operations to convolutions), tensor layouts, dot canonicalization configurations, or accelerator (TPU) memory assignment knobs. Additional parameters that can be optimized through the techniques described herein include those disclosed in Phothilimthana et al., A Flexible Approach to Autotuning Multi-Pass Machine Learning Compilers, 30th International Conference on Parallel Architectures and Compilation Techniques (2021), the entire contents of which are hereby incorporated by reference.

In some implementations, instead of or in addition to being generated using feedback-directed optimization, one or more the optimization profiles 170 stored by the profile data store 150 can be generated (e.g., by the optimization engine 140) at least partially using an auto-tuning technique, including techniques that auto-tune the values of one or more configuration settings of the compilation (such as window sizes and/or overlap selection). An auto-tuner can be configured to process a computer program according to a set of different values for the optimization settings to generate a tuning output that identifies the values for the optimization settings that result in the highest compilation performance, out of all the tested values for the optimization settings in the set. For instance, the configuration settings determined during the tuning process can include one or more of: window sizes, or overlap sections. As a particular example, if the compiler 180 is an Accelerated Linear Algebra (XLA) compiler as described in more detail below, the optimization engine 140 can be (or include) an XLA auto-tuner that is configured to identify, for a particular computer program 120, the best configuration for the compiler 180 when compiling the computer program 120.

In this specification, the compilation performance of a computer program according to particular values for a set of configuration settings encompasses indicators of performance of the compilation process itself or performance of a result of the compilation process (e.g., performance of the compiled computer program), according to any appropriate metric. For example, the compilation performance can represent, at least in part, an indicator of the performance of the compilation process (e.g., as measured by the time and/or computations required to compile the computer program, and/or as measure by an error rate of the compilation). Instead or in addition, the compilation performance can represent, at least in part, an indicator of the performance of the compiled computer program itself (e.g., as measured by the time and/or computations required to execute the compiled computer program, and/or as measured by a correctness of the compiled computer program).

The optimization engine 140 (also called simply an “optimizer”) is configured to add new optimization profiles 142 (corresponding to respective computer programs) to the profile data store 150 and/or to update the existing optimization profiles 170 in the profile data store 150. Although the below description generally refers to “new” optimization profiles 142, it is to be understood that the same techniques can be applied to update existing optimization profiles 170, e.g., by replacing the existing optimization profiles 170 with the newly-updated optimization profiles 142.

In some implementations, the optimization engine 140 continuously generates new optimization profiles 142. For example, after generating a batch of one or more new optimization profiles 142, the optimization engine 140 can be configured to immediately begin execution to generate a next batch of one or more new optimization profiles 142. In some other implementations, the optimization engine 140 is configured to execute periodically. For example, the optimization engine 140 can be configured to generate a batch of one or more new optimization profiles 142, e.g., once per hour, once per day, once per week, or once per month.

The optimization engine 140 can be configured to generate new optimization profiles 142 corresponding to computer programs 120 that are used (e.g., compiled or executed) more often and/or for longer periods of time than other computer programs 120 in the set of computer programs. That is, one of the goals of the compilation system 100 can be to improve the efficiency of the execution of the set of computer programs 120, and the efficiency can be improved by the greatest degree by optimizing the compilation of the computer programs 120 in the set that are most frequently and/or for the longest period of time. Thus, the optimization engine 140 can be configured to obtain a strict subset 112 of the set of computer programs 120, i.e., a subset 112 that includes strictly fewer elements than the set 120 (also called a “proper” subset).

As a particular example, the compilation system 100 can be a component of a computer system (e.g., a computer system implemented on the cloud) that executes a large set of workloads (e.g., thousands, hundreds of thousands, or millions of concurrent workloads) that are at least partially defined by the computer programs 120 (and/or that invoke the computer programs 120). To improve the efficiency of the workloads executing on the computer system, the compilation system 100 can prioritize generating new optimization profiles 142 for the computer programs 120 that are executed most often by the larger system, i.e., the computer programs that are invoked most often by the set of workloads executed by the computer system.

A profiling engine that is a component of the compilation system 100 (e.g., that is a component of the program data store 110 or the optimization engine 140) can be configured to evaluate the set of workloads of the computer system to identify a subset 112 of the set of computer programs 120, where the computer programs in the subset 112 have been determined (or approximated) to have the highest computational load on the computer system (i.e., the highest computational load across the workloads of the computer system) out of the computer programs 120 in the set.

The profiling engine can periodically (e.g., every hour, every day, or every week) record, over a particular period of time (e.g., ten seconds, one minute, ten minutes, one hour, or one day), such data as what workloads are currently executing, what computer programs 120 are the workloads invoking, how long does a particular workload or computer program 120 take to execute, and so on.

The profiling engine can determine or approximate the computational load that respective computer programs 120 have on the computer system using any appropriate metric or set of metrics.

For example, the profiling engine can identify, for each computer program 120, a number of times the computer program 120 is invoked in a particular period of time (e.g., ten seconds, one minute, ten minutes, one hour, or one day). The profiling engine can then determine the subset 112 to include the computer programs 120 that have been invoked the highest number of times or most frequently.

As another example, the profiling engine can identify, for each computer program 120, a number of workloads that are currently executing the computer program at a particular time. The profiling engine can then determine the subset 112 to include the computer programs 120 that are currently being executed by the highest number of workloads.

As another example, the profiling engine can identify, for each computer program 120, a total runtime of the computer program 120 across all workloads over a particular period of time (e.g., ten seconds, one minute, ten minutes, one hour, or one day). The profiling engine can then determine the subset 112 to include the computer programs 120 that have the highest total runtime.

As another example, the profiling engine can determine the subset 112 according to a set of multiple different metrics (e.g., a set that includes one or more of the metrics described above), e.g., by combing the multiple different metrics into a single score and determining the subset 112 to include the computer programs 120 that have the highest score.

In some implementations, the profiling engine can add, to the program data store 110, profiling metadata 130 associated with at least some of the computer programs 120 stored in the program data store 110, where the profiling metadata 130 identifies some or all of the metrics tracked by the profiling engine. That is, at least a portion of the profiling metadata 130 maintained by the program data store 110 can be generated by the profiling engine. For example, the profiling engine can add, for at least some of the computer programs 120, profiling metadata 130 identifying whether the computer program was included in the subset 112 during the current iteration of the profiling engine.

In some implementations, the compilation system 100 executes multiple different instances of the compiler 180 concurrently. For example, respective computer programs 120 can be designed to be compiled by different instances of the compiler 180. In some such implementations, the profiling engine can determine, for each particular instance of the compiler 180, a respective subset 112 of the computer programs, and the optimization engine 140 can then generate (as described below) corresponding new optimization profiles 142 for use by the compiler 180 running the particular instance.

The optimization engine 140 can obtain the subset 112 of computer programs, and generate, for at least some of the computer programs in the subset 112, a respective new optimization profile 142. For each computer program in the subset 112 and for each of multiple sets of values for configuration settings of the compiler 180, the optimization engine 140 can determine a respective compilation performance of the computer program when the computer program is compiled according to the values for the configuration settings of the compiler 180. As described above, the compilation performance can be represented or approximated in any appropriate way, e.g., as an indicator of the performance of the compilation process (e.g., as measured by the time required to compile or an error rate of the compilation) and/or as an indicator of the performance of the compiled computer program itself (e.g., as measured by the time required to execute the compiled computer program or a correctness of the compiled computer program). The optimization engine 140 can then determine the highest-performing configuration of the compiler 180, and generate a new optimization profile 142 identifying the highest-performing configuration (also called the “optimized” configuration).

In some implementations, each new optimization profile 142 also identifies a “default” configuration for compiling the corresponding computer program 120. The default configuration identifies a configuration using which the compiler 180 is to compile the computer program 120 in the absence of an optimized configuration and/or if the compiler 180 were to be unable to use the optimized configuration (e.g., due to an error arising from attempting to compile the computer program 120 using the optimized configuration). The default configuration can correspond to a particular instance, e.g., software version, of the compiler 180; that is, if the software of the compiler 180 is updated, then the default configuration for one or more of the computer programs 120 may change. In some implementations, for a particular software version of the compiler 180, the default configuration can be the same across all computer programs 120; in some other implementations, for a particular software version of the compiler 180, the default configuration can be different for different computer programs 120.

For some computer programs in the subset 112, the optimization engine 140 can determine that no configuration of the compiler 180 leads to an improved compilation performance (e.g., as measured by the time required to compile the computer program) relative to the compilation performance using a default configuration (or that no configuration of the compiler 180 outperforms the default configuration by more than a predetermined threshold, e.g., 1%). In response to this determination, the optimization engine 140 can determine not to generate a new optimization profile 142 for the computer program. That is, the optimization engine 140 can generate fewer new optimization profiles 142 than there are computer programs in the subset 112.

After generating the new optimization profiles 142, the optimization engine 140 can provide the new optimization profiles 142 to the profile data store 150.

In some implementations in which the compilation system 100 is component of a computer system that executes a set of workloads that include the computer programs 120, developers of the workloads can submit new workloads or updates to existing workloads using a submission system that maintains data identifying each submission and the time at which the submission was made. Similarly, developers can submit updates to the software of the compiler 180 using the submission system. For example, the computer system can maintain a sequence of “change lists” (or “CLs”) that each correspond to a respective version of a code repository shared by at least some of the workloads and identify the changes introduced by the version relative to the preceding version. Although the below description generally refers to implementations that use change lists, it is to be understood that the same techniques can be applied in implementations that use any appropriate submission system.

The computer system can be configured to revert to a previous state corresponding to a respective change list, i.e., where the computer system reverts to the state of the computer system (including all workloads of the computer system and the software version of the compiler 180) at the timestamp corresponding to the submission of the change list.

In some such implementations, the optimization engine 140 can submit the new optimization profiles 142 to the profile data store 150 using the same submission system as the developers of the workloads, e.g., by submitting a new change list. For example, the computer system can maintain a file or set of files that define each of the optimization profiles 170 maintained by the profile data store 150. The optimization engine 140 can thus add the new optimization profiles 142 by submitting a change list that updates the file or set of files to include data defining the new optimization profiles 142. In some implementations, the file or set of files is maintained by the compiler 180, e.g., as a dependency of the software version of the compiler 180.

By documenting each submission of a set of new optimization profiles 142 using a respective change list as described above, the compilation system 100 can ensure that the optimization profiles 170 are version controlled. For example, the computer system can determine to revert to a previous change list (i.e., revert to the version of the code repository represented by the change list), which includes reverting to the set of optimization profiles 170 that were stored by the profile data store 150 during that version. In some examples, users can also specify which change list should be applied by the compilation system 100 so that users can select a particular set or version of optimization profiles 170 from a particular time to be used in compiling one or more programs.

In some implementations, the compilation system 100 enforces a time-to-live (TTL) for at least some of the optimization profiles 170 stored in the profile data store 150. That is, for at least some of the optimization profiles 170, the optimization profile 170 is only maintained by the profile data store 150 and used by the compiler 180 to compile the corresponding computer program 120 for a predetermined period of time, after which the optimization profile 170 is removed from the profile data store 150 (or replaced with a new optimization profile 142 corresponding to the computer program 120). For example, at each execution of the optimization engine 140 (which can be configured to periodically execute as described above), at the same time that the optimization 140 adds the new optimization profiles 142 to the profile data store 150, the optimization engine 140 (or a different component of the compilation system 100, e.g., the profile audit engine 160) can remove the existing optimization profiles 170 that have exceeded their respective TTL. As another example, the profile audit engine 160 can be configured to periodically (e.g., once per day or once per week) review each optimization profile 170 (or, alternatively, only the optimization profiles 170 corresponding to computer programs 120 that are currently being executed by the computer system) to determine whether their TTL has expired and, if so, remove the optimization profiles 170 from the profile data store 150. The TTL can be on the order of hours, days, weeks, or months in different implementations. For example, the TTL can be two weeks.

For each computer program 120, the compiler 180 is configured to process the computer program 120 according to a respective optimization profile 170 stored by the profile data store 150 to generate a new compilation output 142.

For example, the compiler 180 (or another subsystem of the compilation system 100) can determine a profile key 184 from the computer program 120, and use the profile key 184 to query the profile data store 150 and obtain optimization profile data 152 representing the optimization profile 170 corresponding to the computer program 120 (i.e., the optimization profile 170 that is to be used to compile the computer program 120).

As a particular example, the compiler 180 can process the computer program 120 or a representation of the computer program 120 (e.g., a protocol buffer corresponding to the computer program 102 or any other embedding of the computer program 120) using a function, e.g., a hash function, to generate the profile key 184. That is, the profile key can be a “fingerprint” of the computer program 120 generated by applying a hash function to the computer program 120. In this specification, an embedding is an ordered collection of numeric values that represents an input in a particular embedding space. For example, an embedding can be a vector of floating point or other numeric values that has a fixed dimensionality.

In some implementations, the compiler 180 generates the profile key using an intermediate representation of the computer program 120 that has been generated during the compilation process (e.g., the compiler can apply a hash function to the intermediate representation, or determine the profile key to be the intermediate representation itself). The compiler 180 can then use the obtained optimization profile data 152 to generate the compilation output 182 from the intermediate representation. For instance, the intermediate representation can be a high level operations (“HLO”) representation, e.g., if the compiler 180 is an XLA compiler.

In some implementations, the optimization profile 170 corresponding to the computer program 120 can be configured for particular hardware that is to execute the compilation output 182. For example, the optimization profile 170 can be configured for a particular software version of an accelerator that is to execute the compilation output 182 (e.g., a particular software version of a tensor processing unit). In these implementations, the compiler 180 can further generate the profile key using data representing the hardware that is to execute the compilation output 182, e.g., by concatenating (i) the fingerprint of the computer program 120 as described above and (ii) a string identifying the software version of the accelerator that is to execute the compilation output 182 to generate the profile key.

The compiler 180 can be any appropriate compiler. In some implementations, the compiler 180 is configured to perform just-in-time compilation.

In some implementations, the compiler 180 is a domain-specific compiler, i.e., a compiler that is configured to compile computer programs that define a particular type of task (i.e., computer programs from a particular task domain). For example, in some implementations in which one or more of the computer programs 120 define respective machine-learning tasks, the compiler 180 can be a domain-specific compiler that is configured to compile computer programs specifically for machine learning tasks. As a particular example, the compiler 180 can be an Accelerated Linear Algebra (“XLA”) compiler.

In some implementations, as described above, the compiler 180 generates the new compilation output 182 in two steps, i.e., first by processing the computer program 120 to generate an intermediate representation of the computer program 120, and second by processing the intermediate representation to generate the new compilation output 182. The optimization profile 170 corresponding to the computer program 120 (as represented by the optimization profile data 152) can be applied in the second step, when the new compilation output 182 is generated from the intermediate representation (e.g., an HLO representation).

The profile audit engine 160 is configured to ensure that each of the optimization profiles 170 stored by the profile data store 150 is valid given the current software version of the compiler 180 (i.e., able to be used by the compiler 180 to compile the respective corresponding computer program 120). The profile audit engine 160 can further be configured to determine, for each optimization profile 170 stored by the profile data store 150, whether the optimization profile 170 causes a higher compilation performance for the computer program (e.g., as measured by efficiency as described above) relative to the corresponding default profile.

In some implementations, at least some of the optimization profiles 170 are dependent upon a particular software version of the compiler 180, e.g., the software version that the compiler 180 had at the time that the optimization profile 170 was generated. An update to the software version of the compiler 180 can in some cases cause the optimization profile 180 to no longer result in a superior compilation relative to the default profile of the new software version of the compiler 180, and can even cause the optimization profile 180 to no longer be valid (e.g., result in errors in the compilation of the corresponding computer program 120).

That is, while a particular optimization profile 170 may have been valid when generated by the optimization engine 140 and added to the profile data store 150, the particular optimization profile 170 may have since become invalidated (i.e., no longer able to be used by the compiler 180 to compile the respective corresponding computer program 120, e.g., without causing an error).

The profile audit engine 160 can thus be configured to perform one or more auditing mechanisms on the optimization profiles 170 in the profile data store 150 in order to remove optimization profiles 170 that should no longer be used to compile the corresponding computer programs 120. In other words, the profile audit engine 160 is configured to determine whether the optimization profiles 170 are valid for the current software version of the compiler 180 (or predict whether the optimization profiles 170 are valid for the current software version of the compiler 180, if the profile audit engine 160 performs auditing mechanisms that do not necessarily definitively determine the validity of the optimization profiles 170).

For example, in implementations in which the compilation system 100 enforces a respective time-to-live on at least some of the optimization profiles 170 as described above, the profile audit engine 160 can periodically (e.g., once per hour, once per day, or once per week) identify the optimization profiles 170 that have exceeded their corresponding TTLs. Enforcing a TTL for an optimization profile 170 can reduce the risk that the optimization profile 170 is maintained past the time at which it is valid.

As another example, in implementations in which the profile data store 150 maintains, for at least some of the optimization profiles 170, data representing a corresponding default profile as described above, the profile audit engine 160 can periodically (e.g., once per hour, once per day, or once per week) determine whether the default profile for the optimization profile 170 matches a default profile identified by the compiler 180. Generally, for a particular software version of the compiler 180, the compiler 180 can publish a default profile that will be used to compile the computer programs 120 if a corresponding optimization profile 170 is not available. Generally, if a particular optimization profile 170 was generated at a time when the compiler 180 had the same particular software version, the default profile associated with the particular optimization profile 170 is expected to match the default profile corresponding to the particular software version of the compiler 180. Thus, if the two default profiles do not match, then the profile audit engine 160 can determine that it is likely the software version of the compiler 180 has changed since the generation of the particular optimization profile 170, and remove the particular optimization profile 170 from the profile data store 150. In some implementations, the profile audit engine 160 performs this auditing mechanism for each optimization profile 170 in the profile data store 150; in some other implementations, the profile audit engine only performs this auditing mechanism for the optimization profiles 170 corresponding to computer programs 120 that are currently being executed. In some implementations, the system can store data that associates each optimization profile with a particular respective software version of the compiler 180, e.g., the most current version of the compiler 180 that was available at the time the profile 170 was generated.

As another example, for at least some of the optimization profiles 170, the profile audit engine 160 can periodically (i) compile the corresponding computer program 120 using the optimization profile 170 and (ii) compile the computer program 120 using a default profile (e.g., a default profile associated with the optimization profile 170 or identified by the compiler 180), and determine whether the compilation using the optimization profile 170 still outperforms the compilation using the default profile. For example, for any appropriate measure of compilation performance (e.g., the time required to complete the compilation), the profile audit engine 160 can determine whether the performance using the optimization profile 170 exceeds the performance using the default profile by a predetermined threshold (e.g., 0.1%, 1%, or 5%) and, if not, remove the optimization profile 170 from the profile data store 150. In some implementations, the profile audit engine 160 performs this auditing mechanism for each optimization profile 170 in the profile data store 150; in some other implementations, the profile audit engine only performs this auditing mechanism for the optimization profiles 170 corresponding to computer programs 120 that are currently being executed.

As another example, in some implementations the compile 180 publishes a list of all valid configurations that can be used to compile respective computer programs 120. For at least some of the optimization profiles 170, the profile audit engine can periodically determine whether the optimization profile 170 is in the list published by the compiler 180 and, if not, remove the optimization profile 170 from the profile data store. In some implementations, the profile audit engine 160 performs this auditing mechanism for each optimization profile 170 in the profile data store 150; in some other implementations, the profile audit engine only performs this auditing mechanism for the optimization profiles 170 corresponding to computer programs 120 that are currently being executed.

As described above, in some implementations the compilation system 100 is a component of a computer system that maintains a sequence of change lists. In some such implementations, instead of performing the one or more auditing mechanisms periodically according to a predetermined schedule, the profile audit engine 160 can trigger the auditing mechanisms in response to a submission of a new change list that modifies the compiler 180, e.g., by updating the software version of the compiler. That is, the profile audit engine 160 can determine that a particular change list has modified the compiler 180, and in response perform one or more auditing mechanisms to determine whether the modification to the compiler 180 has invalidated one or more optimization profiles 170.

In some implementations, in order to remove one or more optimization profiles 170 from the profile data store 150, the profile audit engine 160 also submits a new change list, so that the removal of the one or more optimization profiles 170 can also be version-controlled as described above.

In some implementations, the frequency with which the profile audit engine 160 performs each of the one or more auditing mechanisms (e.g., including one or more of the auditing mechanisms described above) is the same. For instance, the profile audit engine 160 can perform each auditing mechanism concurrently according to a predetermined schedule. In some other implementations, the frequency with which the profile audit engine 160 performs respective different auditing mechanisms is different. For instance, the profile audit engine 160 can compare default profiles more frequently than determining whether respective TTLs have been reached.

The monitoring engine 190 is configured to monitor the use of the optimization profiles 170 when compiling the computer programs for execution by the workloads of the computer system.

In some implementations, when the compiler 180 identifies that the profile data store 150 has an optimization profile 170 corresponding to a computer program 120 to be compiled, and uses the optimization profile 170 to compile the computer program 120, the compiler 180 (or another component of the compilation system 100) can add, to the program data store 110, profiling metadata 130 that is associated with the computer program 120 and that identifies that the computer program has been compiled using an optimization profile (e.g., as opposed to a default profile). The compiler 180 can further add profiling metadata 130 identifying a speedup of the compilation of the computer program 120 when compiling using the optimization profile 170 relative to the default profile and/or profiling metadata 130 identifying features of the optimization profile 170, e.g., identifying the values of the tunable parameters of the optimization profile 170.

The monitoring engine 190 can parse the profiling metadata 130 across the set of computer programs to determine a degree of adoption of the optimization profiles 170 by the workloads, e.g., to determine a proportion of computer programs 120 that have been compiled using respective optimization profiles 170.

In some implementations, the monitoring engine 190 can provide, to a user of the compilation system 100 (e.g., to a developer in charge of maintaining the compilation system 100), an interface representing or otherwise generated from the profiling metadata 130. For example, the monitoring engine 190 can provide a graphical user interface that provides real-time monitoring of the compilation system 100.

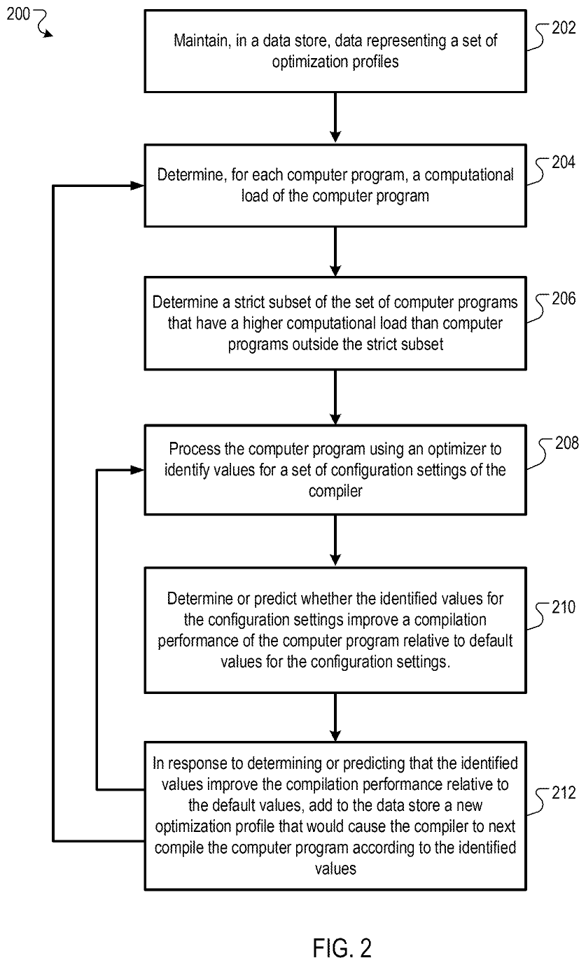

FIG. 2 is a flow diagram of an example process 200 for generating new optimization profiles. For convenience, the process 200 will be described as being performed by a system of one or more computers located in one or more locations. For example, a compilation system, e.g., the compilation system 100 described above with reference to FIG. 1, appropriately programmed in accordance with this specification, can perform the process 200.

The system maintains, in a data store, data representing a set of optimization profiles that are used by a compiler to compile respective computer programs, where the computer programs are invoked by a set of executing workloads (step 202).

In some implementations, at least one of the computer programs defines a task that includes executing a trained machine learning model by processing a model input to generate a model output representing a prediction about the model input. In some such implementations, the compiler is a domain-specific compiler configured to compile computer programs that define machine learning models, e.g., an accelerated linear algebra (XLA) compiler.

The system can repeatedly perform steps 204-212. For example, the system can periodically perform the steps 204-212 at a predetermined frequency.

The system determines, for each computer program in the set of computer programs, a computational load of the computer program across the set of executing workloads (step 204). For example, the system can determine a number of invocations of the computer program by the executing workloads over a period of time. Instead or in addition, the system can determine a number of executing workloads that are currently executing the computer program. Instead or in addition, the system can determine a total runtime of the computer program across the executing workloads over a period of time.

The system determines a strict subset of the set of computer programs that have a higher computational load than computer programs in the set of computer programs that are not in the strict subset (step 206).

The system can repeat steps 208-212 for each computer program in the strict subset.

The system processes the computer program using an optimizer to identify values for a set of configuration settings of the compiler (step 208).

The system determines or predicts whether the identified values for the configuration settings improve a compilation performance of the computer program relative to default values for the configuration settings (step 210). For example, the system can determine whether the identified values improve the compilation performance relative to the default values by more than a predetermined threshold.

For example, the system can determine the compilation performance of a computer program according to particular values for the configuration settings using to one or more of: a time and/or quantity of computations required to compile the computer program, an error rate of the compilation, a time and/or quantity of computations required to execute the compiled computer program, or a correctness of the compiled computer program.

In response to determining or predicting that the identified values improve the compilation performance of the computer program relative to the default values, the system adds, to the data store, a new optimization profile that would cause the compiler to next (e.g., the next time that the computer program is invoked or the next time that a request is submitted to the compiler to compile the computer program) compile the computer program according to the identified values. For example, the system can generate the new optimization profile for the computer program using the identified values and update the maintained data representing the set of optimization profiles to include the new optimization profile. As a particular example, the system can submit a change list to a code repository of the executing workloads.

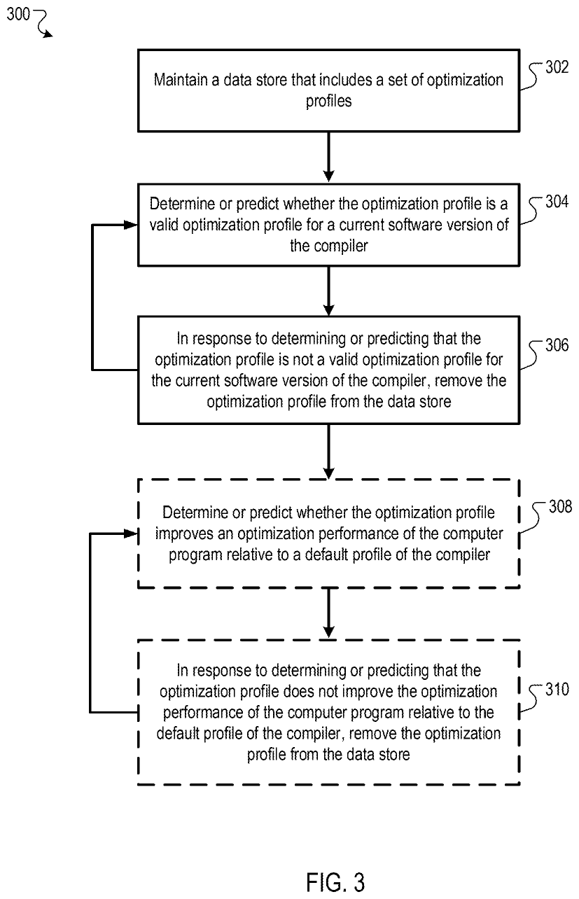

FIG. 3 is a flow diagram of an example process 300 for determining whether existing optimization profiles are valid. For convenience, the process 300 will be described as being performed by a system of one or more computers located in one or more locations. For example, a compilation system, e.g., the compilation system 100 described above with reference to FIG. 1, appropriately programmed in accordance with this specification, can perform the process 300.

The system maintains a data store that includes a set of optimization profiles that are used by a compiler to compile respective computer programs, where the computer programs are invoked by a set of executing workloads (step 302).

In some implementations, at least one of the computer programs defines a task that includes executing a trained machine learning model by processing a model input to generate a model output representing a prediction about the model input. In some such implementations, the compiler is a domain-specific compiler configured to compile computer programs that define machine learning models, e.g., an accelerated linear algebra (XLA) compiler.

The system can repeatedly perform steps 304-306. For example, the system can periodically perform the steps 304-306 at a predetermined frequency. As another example, the system can perform the steps 304-306 in response to determining that a new change list submitted to a code repository of the set of executing workloads includes a modification to the compiler.

At each execution of the steps 304-306, the system can repeat the steps 304-306 for each optimization profile in at least a subset of the optimization profiles.

The system determines or predicts whether the optimization profile is a valid optimization profile for a current software version of the compiler (step 304). For example, the system can determine that a time-to-live of the optimization profile has expired. Instead or in addition, the system can determine that (i) a default profile associated with the optimization profile and (ii) a default profile of the compiler do not match. Instead or in addition, the system can determine that the optimization profile is not an entry in a list of valid optimization profiles published by the optimizer.

In response to determining or predicting that the optimization profile is not a valid optimization profile for the current software version of the compiler, the system removes the optimization profile from the data store (step 306). For example, the system can submit a new change list to a code repository of the set of executing workloads.

Optionally, the system can repeatedly perform steps 308-310. For example, the system can periodically perform the steps 308-310 at a predetermined frequency. As another example, the system can perform the steps 308-310 in response to determining that a new change list submitted to a code repository of the set of executing workloads includes a modification to the compiler.

At each execution of the steps 304-306, the system can repeat the steps 304-306 for each optimization profile in at least a subset of the optimization profiles.

The system determines or predicts whether the optimization profile improves an optimization performance of the computer program relative to a default profile of the compiler (step 308). For example, the system can determine or predict whether the optimization profile improves the optimization performance relative to the default profile by more than a predetermined threshold.

In response to determining or predicting that the optimization profile does not improve the optimization performance of the computer program relative to the default profile of the compiler, the system removes the optimization profile from the data store (step 310). For example, the system can submit a new change list to a code repository of the set of executing workloads.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments of the attached claims and the embodiments described above, the following numbered embodiments are also innovative:

Embodiment 1 is a method comprising: maintaining, in a data store, data representing a plurality of optimization profiles that are used by a compiler to compile respective computer programs, wherein the computer programs are invoked by a set of executing workloads; and repeatedly performing operations comprising: determining, for each of the plurality of computer programs, a computational load of the computer program across the set of executing workloads; determining a strict subset of the plurality of computer programs that have a higher computational load than computer programs of the plurality of computer programs that are outside the strict subset; and for each computer program in the strict subset: processing the computer program using an optimizer to identify values for a set of configuration settings of the compiler; determining or predicting whether the identified values for the configuration settings improve a compilation performance of the computer program relative to default values for the configuration settings; and in response to determining or predicting that the identified values improve the compilation performance of the computer program relative to the default values, adding to the data store a new optimization profile that would cause the compiler to next compile the computer program according to the identified values.

Embodiment 2 is the method of embodiment 1, wherein determining the computational load of a computer program across the set of executing workloads comprises one or more of: determining a number of invocations of the computer program by the executing workloads over a period of time, determining a number of executing workloads that are currently executing the computer program, or determining a total runtime of the computer program across the executing workloads over a period of time.

Embodiment 3 is the method of any one of embodiments 1 or 2, wherein determining or predicting whether the identified values for the configuration settings improve a compilation performance of the computer program relative to default values for the configuration settings comprises determining or predicting whether the identified values for the configuration settings improve a compilation performance of the computer program relative to default values for the configuration settings by more than a predetermined threshold.

Embodiment 4 is the method of any one of embodiments 1-3, wherein the compilation performance of a computer program according to particular values for the configuration settings is determined according to one or more of: a time and/or quantity of computations required to compile the computer program, an error rate of the compilation, a time and/or quantity of computations required to execute the compiled computer program, or a correctness of the compiled computer program.

Embodiment 5 is the method of any one of embodiments 1-4, wherein adding the new optimization profile to the data store comprises submitting a change list to a code repository of the executing workloads.

Embodiment 6 is the method of any one of embodiments 1-5, wherein at least one of the computer programs defines a task comprising executing a trained machine learning model by performing operations comprising processing a model input to generate a model output representing a prediction about the model input.

Embodiment 7 is the method of any one of embodiments 1-6, wherein the compiler is a domain-specific compiler configured to compile computer programs that define tasks for training machine learning models, executing trained machine learning models, or both.

Embodiment 8 is the method of embodiment 7, wherein the compiler is an accelerated linear algebra (XLA) compiler.

Embodiment 9 is a method comprising: maintaining a data store comprising a plurality of optimization profiles that are used by a compiler to compile respective computer programs, wherein the computer programs are invoked by a set of executing workloads; and repeatedly performing operations comprising: for each optimization profile in at least a subset of the optimization profiles: determining or predicting whether the optimization profile is a valid optimization profile for a current software version of the compiler; and in response to determining or predicting that the optimization profile is not a valid optimization profile for the current software version of the compiler, removing the optimization profile from the data store.

Embodiment 10 is the method of embodiment 9, wherein determining or predicting that the optimization profile is not a valid optimization profile for a current software version of the compiler comprises one or more of: determining that a time-to-live of the optimization profile has expired, determining that (i) a default profile associated with the optimization profile and (ii) a default profile of the compiler do not match, or determining that the optimization profile is not an entry in a list of valid optimization profiles published by the optimizer.

Embodiment 11 is the method of any one of embodiments 9 or 10, further comprising repeatedly performing operations comprising: for each optimization profile in at least a subset of the optimization profiles: determining or predicting whether the optimization profile improves an optimization performance of the computer program relative to a default profile of the compiler; and in response to determining or predicting that the optimization profile does not improve the optimization performance of the computer program relative to the default profile of the compiler, removing the optimization profile from the data store.

Embodiment 12 is the method of embodiment 11, wherein determining or predicting whether the optimization profile improves an optimization performance of the computer program relative to a default profile of the compiler comprises determining or predicting whether the optimization profile improves an optimization performance of the computer program relative to a default profile of the compiler by more than a predetermined threshold.

Embodiment 13 is the method of any one of embodiments 9-12, wherein repeatedly performing the operations comprises one or more of: periodically performing the operations at a predetermined frequency, or performing the operations in response to determining that a new change list submitted to a code repository of the set of executing workloads includes a modification to the compiler.

Embodiment 14 is the method of any one of embodiments 9-13, wherein removing the optimization profile from the data store comprises submitting a new change list to a code repository of the set of executing workloads.

Embodiment 15 is the method of any one of embodiments 9-14, wherein at least one of the computer programs defines a task comprising executing a trained machine learning model by performing operations comprising processing a model input to generate a model output representing a prediction about the model input.

Embodiment 16 is the method of embodiment 15, wherein the compiler is a domain-specific compiler configured to compile computer programs that define tasks for training machine learning models, executing trained machine learning models, or both.

Embodiment 17 is the method of embodiment 16, wherein the compiler is an accelerated linear algebra (XLA) compiler.

Embodiment 18 is a system comprising one or more computers and one or more storage devices storing instructions that when executed by the one or more computers cause the one or more computers to perform the methods of any one of embodiments 1-17.

Embodiment 19 is or more computer storage media storing instructions that when executed by one or more computers cause the one or more computers to perform the methods of any one of embodiments 1-17.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
maintaining, in a data store, data representing a plurality of optimization profiles that are used by a compiler to compile respective computer programs, wherein the computer programs are invoked by a set of executing workloads; and
repeatedly performing operations comprising:
determining, for each of the plurality of computer programs, a computational load of the computer program across the set of executing workloads;
determining a strict subset of the plurality of computer programs that have a higher computational load than computer programs of the plurality of computer programs that are outside the strict subset; and
for each computer program in the strict subset:
processing the computer program using an optimizer to identify values for a set of configuration settings of the compiler;
determining or predicting whether the identified values for the configuration settings improve a compilation performance of the computer program relative to default values for the configuration settings; and
in response to determining or predicting that the identified values improve the compilation performance of the computer program relative to the default values, adding to the data store a new optimization profile that would cause the compiler to next compile the computer program according to the identified values.

2. The method of claim 1, wherein determining the computational load of a computer program across the set of executing workloads comprises one or more of:
determining a number of invocations of the computer program by the executing workloads over a period of time,
determining a number of executing workloads that are currently executing the computer program, or
determining a total runtime of the computer program across the executing workloads over a period of time.

3. The method of claim 1, wherein determining or predicting whether the identified values for the configuration settings improve a compilation performance of the computer program relative to default values for the configuration settings comprises determining or predicting whether the identified values for the configuration settings improve a compilation performance of the computer program relative to default values for the configuration settings by more than a predetermined threshold.

4. The method of claim 1, wherein the compilation performance of a computer program according to particular values for the configuration settings is determined according to one or more of:
a time and/or quantity of computations required to compile the computer program,
an error rate of the compilation,
a time and/or quantity of computations required to execute the compiled computer program, or
a correctness of the compiled computer program.

5. The method of claim 1, wherein adding the new optimization profile to the data store comprises submitting a change list to a code repository of the executing workloads.

6. The method of claim 1, wherein at least one of the computer programs defines a task comprising executing a trained machine learning model by performing operations comprising processing a model input to generate a model output representing a prediction about the model input.

7. The method of claim 1, wherein the compiler is a domain-specific compiler configured to compile computer programs that define tasks for training machine learning models, executing trained machine learning models, or both.

8. The method of claim 7, wherein the compiler is an accelerated linear algebra (XLA) compiler.

9. A method comprising:
maintaining a data store comprising a plurality of optimization profiles that are used by a compiler to compile respective computer programs, wherein the computer programs are invoked by a set of executing workloads; and
repeatedly performing operations comprising:
for each optimization profile in at least a subset of the optimization profiles:
determining or predicting whether the optimization profile is a valid optimization profile for a current software version of the compiler; and
in response to determining or predicting that the optimization profile is not a valid optimization profile for the current software version of the compiler, removing the optimization profile from the data store.

10. The method of claim 9, wherein determining or predicting that the optimization profile is not a valid optimization profile for a current software version of the compiler comprises one or more of:
determining that a time-to-live of the optimization profile has expired,
determining that (i) a default profile associated with the optimization profile and (ii) a default profile of the compiler do not match, or
determining that the optimization profile is not an entry in a list of valid optimization profiles published by the optimizer.

11. The method of claim 9, further comprising repeatedly performing operations comprising:
for each optimization profile in at least a subset of the optimization profiles:
determining or predicting whether the optimization profile improves an optimization performance of the computer program relative to a default profile of the compiler; and
in response to determining or predicting that the optimization profile does not improve the optimization performance of the computer program relative to the default profile of the compiler, removing the optimization profile from the data store.

12. The method of claim 11, wherein determining or predicting whether the optimization profile improves an optimization performance of the computer program relative to a default profile of the compiler comprises determining or predicting whether the optimization profile improves an optimization performance of the computer program relative to a default profile of the compiler by more than a predetermined threshold.

13. The method of claim 9, wherein repeatedly performing the operations comprises one or more of:
periodically performing the operations at a predetermined frequency, or
performing the operations in response to determining that a new change list submitted to a code repository of the set of executing workloads includes a modification to the compiler.

14. The method of claim 9, wherein removing the optimization profile from the data store comprises submitting a new change list to a code repository of the set of executing workloads.

15. The method of claim 9, wherein at least one of the computer programs defines a task comprising executing a trained machine learning model by performing operations comprising processing a model input to generate a model output representing a prediction about the model input.

16. The method of claim 15, wherein the compiler is a domain-specific compiler configured to compile computer programs that define tasks for training machine learning models, executing trained machine learning models, or both.

17. The method of claim 16, wherein the compiler is an accelerated linear algebra (XLA) compiler.

18. One or more non-transitory computer storage media storing instructions that, when executed by one or more computers, cause the one or more computers to perform operations comprising:
maintaining a data store comprising a plurality of optimization profiles that are used by a compiler to compile respective computer programs, wherein the computer programs are invoked by a set of executing workloads; and
repeatedly performing operations comprising:
for each optimization profile in at least a subset of the optimization profiles:
determining or predicting whether the optimization profile is a valid optimization profile for a current software version of the compiler; and
in response to determining or predicting that the optimization profile is not a valid optimization profile for the current software version of the compiler, removing the optimization profile from the data store.

19. The one or more non-transitory computer storage media of claim 18, wherein determining or predicting that the optimization profile is not a valid optimization profile for a current software version of the compiler comprises one or more of:
determining that a time-to-live of the optimization profile has expired,
determining that (i) a default profile associated with the optimization profile and (ii) a default profile of the compiler do not match, or
determining that the optimization profile is not an entry in a list of valid optimization profiles published by the optimizer.

20. The one or more non-transitory computer storage media of claim 18, wherein determining or predicting that the optimization profile is not a valid optimization profile for a current software version of the compiler comprises one or more of:
determining that a time-to-live of the optimization profile has expired,
determining that (i) a default profile associated with the optimization profile and (ii) a default profile of the compiler do not match, or
determining that the optimization profile is not an entry in a list of valid optimization profiles published by the optimizer.
